(19) United States
(12) Patent Application Publication
(10) Pub. No.: US 2018/0059801 A1
(43) Pub. Date: Mar. 1, 2018

(54) Systems and Methods for Computer Input

(71) Applicants: Bilge Acun, Urbana, IL (US); Enver Candan, Champaign, IL (US)

(72) Inventors: Bilge Acun, Urbana, IL (US); Enver Candan, Champaign, IL (US)

(21) Appl. No.: 15/252,163

(22) Filed: Aug. 30, 2016

(51) Int. Cl. G06F 3/023; G06F 3/02

(52) U.S. Cl. CPC G06F 3/0234; G06F 3/0338; G06F 3/0213

(57) ABSTRACT

Systems and method are provided for entering alphanumeric input into an electronic device. The systems include two devices with a viscoelastic casing in the size of a user's hand, and a plurality of sensors are arranged such that when the user grasps the holding section, the user's fingers substantially overlay the keys. The device may also include a pointer control device such as accelerometer to control the pointer in a computer without the need for the user from switching between another pointer control device such as a mouse and the handheld keyboard. When the user applies a pressure to a sensor, the viscoelastic casing deforms until the internal strain equals to the pressure.

### BACKGROUND OF THE INVENTION

The present invention generally relates to computer peripherals. More particularly, the present invention relates to systems and devices for entering input to a computer.

The computers have become the focal point of most people's daily lives. There are three main methods a person interfaces with computers; keyboard, mouse, and more recently touch screens. Although touch screens have become more common place in recent years, the effectiveness and the efficiency of keyboards for entering alphanumeric input to a computer is not yet replaced. A standard keyboard sold in the united states contains at least the alphabet from A to Z, numbers 0-9, several functional keys (such as control, alt, tab, enter, shift, etc.,), and punctuation (such as comma, period, colon, etc.). The primary function of a computer keyboard, entering alphanumeric input, can be replicated by using 26 keys. Different keyboards targeted at different language speaking countries may have more characters in their alphabet.

There are commercially available keyboards in various forms. However, current keyboard systems usually require the keyboard to rest on a flat surface because of size, weight, or use.

Prolonged use of keyboards on flat surfaces without support leads to various medical problems such as carpel tunnel syndrome, neck, shoulder, and/or back pain. Every year more than 500,000 people in the U.S. undergo surgeries for carpal tunnel syndrome. This doesn't include undiagnosed patients, people who elect not to have surgery, and those whose conditions are not yet sufficient to have surgery. Yet, keyboard use is essential to interfacing with a computer despite scientific progress in voice recognition software.

U.S. Pat. No. 7,774,155 ('155 patent), discloses an “Accelerometer-based controller.” The '155 patent discloses that “the controller includes a housing formed by plastic molding or the like.” The '155 patent includes a two-piece game control system used by a player to input motion and game input to a computer. (Col. 8, 1. 15). The system and apparatus also includes one or more accelerometers or gyroscopes to generate motion data. (Col. 11, 1. 68). The apparatus also includes a plurality of operation buttons. (Col. 8,1. 23).

U.S. Pat. No. 6,164,853 ('853 patent) discloses an ergonomic remote control housing for a handheld device. The housing contains multiple keys for a remote control placed in rows on the housing face within close proximity of the operator's natural finger positions and additional remote control keys placed within close proximity of the operator's natural thumb position. ('853 patent, Col. 2, 1. 43). The '853 patent discloses a housing composed of hard plastic material.

U.S. Pat. No. 9,256,296 ('296 patent), relates to a keyboard resting on a flat surface integrated with a traditional mouse. ('296 patent, Col. 2, 1. 33). The '296 patent includes two joysticks controlled by the thumb, and 18 keys on the top surface of the device. ('296 patent, Col. 3, 1. 30). In the '296 patent, the trackball rests at the bottom and on a flat surface during use. ('296 patent, Col. 3, 1. 56).

### BRIEF SUMMARY OF THE INVENTION

One or more of a handheld keyboard for entering alphanumeric characters in a target system having a wireless receiver. The handheld keyboard includes a casing having a top end, a bottom end, a control surface, a palm surface and sized to be operated by one hand of a user. The casing is viscoelastic, and when a user holds the casing, the casing deforms under pressure and conforms to the user's hand. The handheld keyboard also includes a processor enclosed within the casing. The processor stores data representing an alphanumeric set. The alphanumeric set includes a plurality of sensor codes, each sensor code corresponds to at least one alphanumeric character and each sensor code is different.

The handheld keyboard also includes a plurality of sensors located in the control surface of the casing for generating input data related to the activation by the user. The plurality of sensors is arranged such that when the user's palm is disposed on the palm surface, the user's fingers rest on the plurality of sensors. Each of the plurality of sensors is associated with one of the sensor codes. The plurality of sensors is electronically connected to the processor. The plurality of sensors is operable as part of a user interface to generate alphanumeric input signals in response to a user activating the plurality of sensors when the user is holding the casing such that the user's palm is disposed along the palm surface and at least one of the user's fingers resting on the control surface.

The handheld keyboard also includes a storage device for at least temporarily storing the input data.

The handheld keyboard also includes a wireless communication device disposed within the casing operatively connected to the processor and operable in use to transmit signals representing input data to the target system.

### BRIEF DESCRIPTION OF THE DRAWINGS

FIG. 1 illustrates an exemplary embodiment of a two-piece keyboard system.

FIG. 2 illustrates another exemplary embodiment two-piece keyboard system a flow chart of an embodiment of the method for determining the user target MED.

FIG. 3 illustrates the exterior view of a viscoelastic handheld keyboard.

FIG. 4 illustrates viscoelastic material behavior during stress-relaxation

FIG. 5 illustrates viscoelastic material behavior under constant stress.

FIG. 6 illustrates another exemplary embodiment two-piece handheld keyboard system.

### BRIEF DESCRIPTION OF THE INVENTION

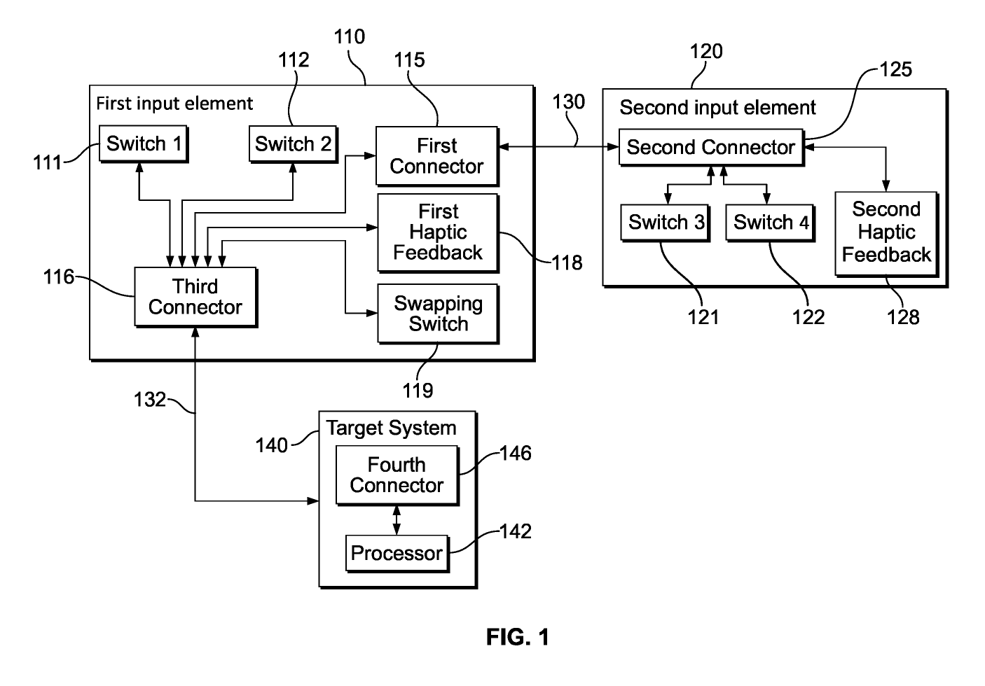

FIG. 1 illustrates a two-piece keyboard system 100. The two-piece keyboard system 100 includes a first input element 110, a second input element 120, a first communication link 130, a second communication link 132, and a target system 140. The first input element 110 includes a first sensor 111, a second sensor 112, a first connecter 115, a third communication port 116, a first haptic feedback device 118, and a swapping sensor 119. The second input element 120 includes a second communication port 125, a third sensor 121, a fourth sensor 122, and a haptic feedback device 128. The target system 140 includes a processor 142, and a fourth communication port 146.

In the first input element 110, the first sensor 111, the second sensor 112, and the swapping sensor 119 are electronically connected to the third communication port 116 and operably connected to transmit electrical current to the third communication port 116 when the sensor is activated. The first communication port 115 is in two-way electronic communication with and operably connected to transmit and receive electronic signals to the third communication port 116. The first haptic feedback device 118 is in two-way communication with the third communication port 116.

In the second input element 120, the second communication port 115 is electronically connected to the first communication link 130. The first communication port 115 is in two-way communication with the second communication port 125 through the first communication link 130. The third sensor 121 and the fourth sensor 122 are in two way communications with the second communication port 125. The second haptic feedback 128 is in one way communications with the second communication port 125.

In the target system 140, the fourth communication port 146 is operably coupled to the second communication link 132. The fourth communication port 146 is in two-way communication with the third communication port 116 through the second communication link 132. The fourth communication port 146 is in two-way communication with the processor 142.

The processor 142 stores data representing an alphanumeric set. The alphanumeric set includes a plurality of sensor codes corresponding to a set of alphanumeric characters. Each sensor code is different and assigned to one of the sensors in the first input element 110 or the second input element 120. The set of alphanumeric characters include characters commonly found in an American computer keyboard. The alphanumeric set also includes three subsets. The master subset includes a subset of the alphanumeric characters and associated sensor codes for the sensors found on the first input element. The second subset includes a subset of the alphanumeric characters and associated sensor codes for the sensors found on the second input element 120. The third subset includes a swapping code associated with the swapping sensor.

The sensor code is a series of numbers and letters identifying the sensor. Each sensor is coupled to a connecter in such a way that when the sensor is activated, the communication port detects the electrical current and is capable of determining the source of the current. The sensors are push buttons which momentarily close a circuit when a pressure is applied to the button and quickly return to its original position when the pressure is removed. The push buttons may include a spring or a deformable elastic material that deforms under the pressure, but springs the sensor to the original position when the pressure is removed.

In operation, when the first sensor 111 or the second sensor 112 is activated, the activated sensor sends an electrical signal representing the sensor code assigned to the activated sensor to the third communication port 116. The third communication port 116 relays the electrical signal to the fourth communication port 146 through the second communication link 132. The fourth communication port relays the electrical signal to the processor 142. The processor 142 finds the alphanumeric character associated with the sensor code and determines the activated sensor as the sensor associated with the alphanumeric character. The processor 142 sends a haptic signal representing a command to activate the first haptic feedback device 118 to the fourth communication port 146. The fourth communication port 146 relays the signal to the third communication port 116, which relays the signal to the first haptic feedback device 118. When the first haptic feedback device 118 receives the haptic signal, the haptic feedback device gives a motional response such as vibration. The vibration can be accomplished using a small motor and a small half circle weight attached to the small motor such that the uneven weight, when rotated, creates a vibration in the first input element that alerts the user that a key is activated.

When the third sensor 111 or the fourth sensor 112 is activated, the activated sensor sends an electrical signal representing the sensor code assigned to the activated sensor to the second communication port 125. The second communication port 125 relays the electrical signal to the first communication port 115 through the first communication link 130. The first communication port 115 relays the electrical signal to the third communication port 116. The third communication port 116 relays the electrical signal to the fourth communication port 146 through the second communication link 132. The fourth communication port 146 relays the electrical signal to the processor 142. The processor 142 finds the alphanumeric character associated with the sensor code and determines the activated sensor as the sensor representing the alphanumeric character. The processor 142 sends a haptic signal representing a command to activate the second haptic feedback device 118 to the fourth communication port 146. The fourth communication port 146 relays the signal to the third communication port 116, which relays the signal to the first communication port 115. The signal travels through the first communication link 130 and the second communication port 125 and reaches the second haptic feedback device 128. When the second haptic feedback device receives the haptic signal, the haptic feedback device gives a motional response such as vibration as explained above.

When the swapping sensor 119 is activated, the swapping sensor sends an electronic signal representing the swapping code to the third communication port 116. The third communication port 116 relays the electrical signal to the fourth communication port 146 through the second communication link 132. The fourth communication port 146 relays the electrical signal to the processor 142. The processor 142 identifies the swapping code from the alphanumeric set. The processor 142 then modifies the alphanumeric set such that the alphanumeric characters in the master subset are replaced with the alphanumeric characters in the second subset.

In an alternative embodiment, the sensors may each include a small light source that illuminates the sensor when the system is activated.

In an alternative embodiment, the third communication port 116 and the fourth communication port 146 are wireless transmitters. In operation, when the third communication port 116 receives an electrical signal representing the code for the activated sensor, it broadcasts a wireless signal representing the code for the activated sensor. When the fourth communication port 146 is in the broadcast range of the third communication port 116, it receives the wireless signal. The fourth communication port 146 than transmits and electrical signal representing the code for the activated sensor to the processor 142. In such embodiment, the second communicator 130 is used to transmit power to the system.

In an alternative embodiment, the first communication port 115 and the second communication port 125 are wireless transmitters, and the first communication link 130 is a wireless communication link. In operation, when the second communication port 116 receives an electrical signal representing the code for the activated sensor, it broadcasts a wireless signal representing the sensor code for the activated sensor. When the first communication port 115 is in the broadcast range of the second communication port 125, it receives the wireless signal. The first communication port 115 than transmits an electrical signal representing the sensor code for the activated sensor to the third communication port 116.

In alternative embodiments, the alphanumeric set may include in alphabets other than English such as Greek, Latin, German, Spanish, etc. The characters may also include punctuation such as comma, period, semicolon, colon, etc., or alternative characters such as “*, $, #, @.” It may also include functional keys such as control, shift, or function. Alternatively, the alphanumeric set may include any combination of letters, punctuation, alternative characters, or modification keys. The alphanumeric set may also be included in a computer program in a traditional computer and capable of being modified by a user.

In alternative embodiments, in response to the activation of the swapping sensor 119, the processor 140 may modify only part of the alphanumeric character subset. In such embodiment, the processor 140 may change only a single switches assignment from one alphanumeric character to another.

In alternative embodiments, the first communication link 130 and the second communication link 132 are wired cables. In such alternative, the communicators include at least one conductive wire to transmit electrical signals between the communication ports. The wire may include copper, gold, or any other suitable conductive material. In an alternative embodiment, the first communication link 130 and the second communication link 132 are standard universal serial bus cables. In an alternative embodiment, the first communication port 115 and the second communication port 125 are universal serial buses. In another alternative the third communication port 116 and the fourth communication port 146 are universal serial buses. In alternative embodiments the communication ports may be Apple® Lightning® communication port, USB-C, USB-3, micro-USB, or any other standard or non-standard communication port.

In an alternative embodiment, the first communication link 130 includes a power cable to transmit power through the fourth communication port to the first input element. In such embodiment, the target system 140 also includes a power supply such as AC or DC power. In alternative embodiments, the target system is a personal computer, a laptop computer, gaming consoles, smart television, cellphones, mobile phones, or tablets.

In an alternative embodiment, the first input element 110 may also include a power sensor. In such alternative in operation, a user activates the power sensor, the system is provided with power. The power may be provided as a rechargeable or disposable battery, or the power may be drawn from the target system 140.

In alternative embodiments, there may be more than two sensors in the first input element 110. In alternative embodiments there may be up to thirty-six sensors in the first input element 110. In an alternative embodiment there are fifteen sensors in the first input element 110. In an alternative embodiment there are eighteen sensors in the first input element 110. In alternative embodiments, there may be more than two sensors in the second input element 120. In alternative embodiments there may be up to thirty-six sensors in the second input element 120. In an alternative embodiment there are fifteen sensors in the second input element 120. In an alternative embodiment there are eighteen sensors in the second input element 120.

In alternative embodiments, the haptic feedback devices may also include a speaker to give an audible feedback in addition to, or in lieu of, the haptic feedback.

In alternative embodiments, the processor 114 may include at least two pins. In such embodiment, the sensors are operably coupled to the pins on the processor 114.

In alternative embodiments, the sensors are detection devices capable of detecting the user's desired activation of the sensor, such as pressure sensors, touch panels, or capacitive panels.

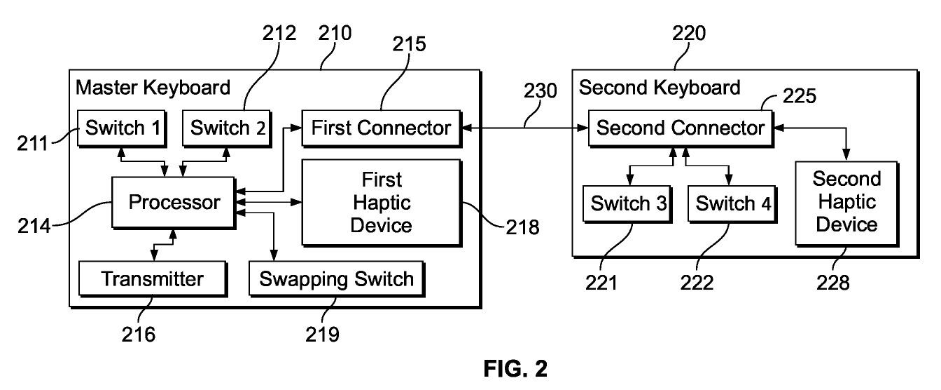

FIG. 2 illustrates a two-piece keyboard system 200. The two-piece keyboard system 200 includes a first input element 210, a second input element 220, and a communication link 230. The first input element 210 includes a first sensor 211, a second sensor 212, a first connecter 215, a transmitter 216, a swapping sensor 219, and a first haptic device 218. The second input element 220 includes a second communication port 225, a third sensor 221, a fourth sensor 222, and a second haptic device 218.

In the first input element 210, the first sensor 211, the second sensor 212, the swapping sensor 219, the first communication port 215, the transmitter 216, and the haptic feedback 218 are in two-way electronic communication with the processor 214 and operably connected to transmit and receive electronic signals to the processor 214.

In the second input element 220, the communication link 230 is operably coupled to and in two-way communication with the second communication port 225. The first communication port 215 is in two-way communication with the second communication port 225 through the communication link 230. The third sensor 221 and the fourth sensor 222 are in two-way communication with the second communication port 225. The second haptic feedback 228 is in one way communications with and configured to receive signals from the second communication port 225.

The processor 242 stores data representing an alphanumeric set. The alphanumeric set includes a plurality of sensor codes corresponding to a set of alphanumeric characters. Each sensor code is different and assigned to one of the sensors in the first input element 210 or the second input element 220. The set of alphanumeric characters include characters commonly found in an American computer keyboard. The alphanumeric set also includes three subsets. The master subset includes a subset of the alphanumeric characters and associated sensor codes for the sensors found on the first input element. The second subset includes a subset of the alphanumeric characters and associated sensor codes for the sensors found on the second input element 220. The third subset includes a swapping code associated with the swapping sensor.

In operation, when the first sensor 211 or the second sensor 212 is activated, the activated sensor sends an electrical signal representing the sensor code assigned to the activated sensor to the processor 214. The processor 242 finds the alphanumeric character associated with the sensor code and determines the activated sensor as the sensor representing the alphanumeric character. The processor 142 sends a haptic signal representing a command to activate the first haptic device 218 to the haptic device 218. When the first haptic device 218 receives the haptic signal, the haptic feedback device gives a motional response. The vibration is accomplished using a small motor and a small half circle weight attached to the small motor such that the uneven weight, when rotated, creates a vibration in the first input element that alerts the user that a key is activated.

When the third sensor 221 or the fourth sensor 222 is activated, the activated sensor sends an electrical signal representing the sensor code assigned to the activated sensor to the second communication port 225. The second communication port 225 relays the signal through the communication link 230 to the first communication port 215, which relays the electrical signal to the processor 214. The processor 242 finds the alphanumeric character associated with the sensor code and determines the activated sensor as the sensor representing the alphanumeric character. The processor 142 sends a haptic signal representing a command to activate the second haptic device 228 to the haptic device 228. The haptic signal is sent to the first communication port 215 which relays the haptic signal to the second communication port 225 through the communication link 230. The second communication port 225 sends the signal to the second haptic device 228. When the second haptic device 228 receives the haptic signal, the haptic feedback device gives a motional response such as vibration. The vibration can be accomplished using a small motor and a small half circle weight attached to the small motor such that the uneven weight, when rotated, creates a vibration in the first input element that alerts the user that a key is activated.

In an alternative embodiment, the first input element 210 may also contain a battery coupled to the processor to supply power to the two-piece keyboard system 200. In such alternative the processor 210 is also capable of transmitting power through the first communication port 215 and the communication link 230 to the second communication port 225. In such alternative, the communication link 230 also includes a power cable to transmit power to the second communication port 225.

In an alternative embodiment, the first input element 210 may also include a wireless transmitter. The wireless transmitter is in two-way communication with the processor 214. When the processor 240 identifies the alphanumerical character associated with the activated sensor, the processor transmits an electrical signal to the alphanumerical character to the wireless transmitter. The wireless transmitter broadcasts a wireless signal representing the alphanumerical character. In an alternative embodiment, the two-piece keyboard system 200 also includes a wireless receiver. The wireless receiver is operably coupled to the wireless transmitter. When the wireless receiver is in the operable range of the wireless transmitter, the wireless receiver receives the wireless signal representing the alphanumeric character.

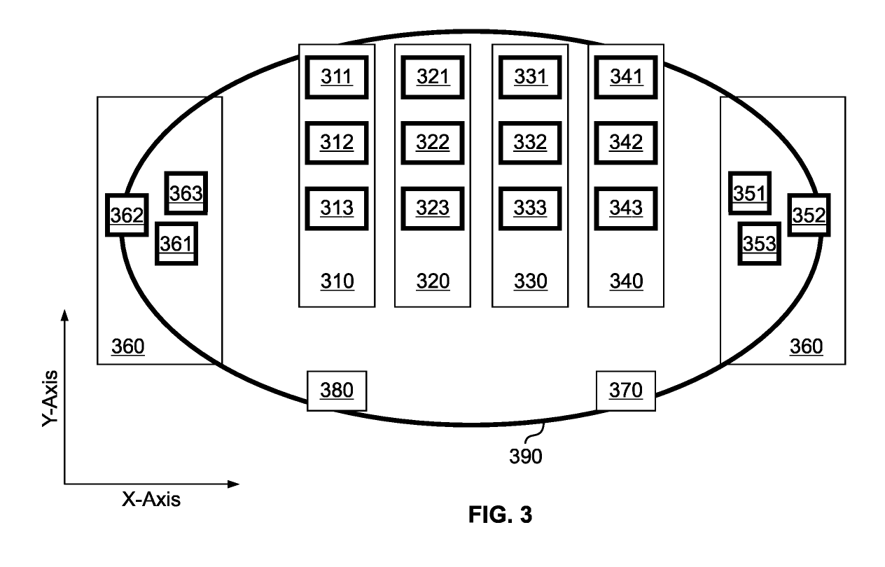

FIG. 3 illustrates the exterior view of a viscoelastic handheld keyboard 300. The viscoelastic handheld keyboard system 300 includes a casing 390, a first sensor set 310, a second sensor set 320, a third sensor set 330, a fourth sensor set 340, a first thumb sensor set 350, a second thumb sensor set 360, a communication port 370, and a swapping sensor 380. The first sensor set 310 include three sensors 311-313 substantially along a straight line along the y axis as shown in FIG. 3. The second sensor set 320 include three sensors 321-323 substantially along a straight line along the y axis as shown in FIG. 3. The third sensor set 330 include three sensors 331-333 substantially along a straight line along the y axis as shown in FIG. 3. The fourth sensor set 340 include three sensors 341-343 substantially along a straight line along the y axis as shown in FIG. 3. The first thumb sensor set 350 include three sensors 351-353 substantially along a straight line along the x axis as shown in FIG. 3. The second thumb sensor set 360 include three sensors 361-363 substantially along a straight line along the x axis as shown in FIG. 3. It should be understood that the axes are shown in the FIG. 3 describes an embodiment of the invention in the properly oriented page and is not intended to limit the application of the invention to any particular embodiment.

In the viscoelastic handheld keyboard 300, the first sensor set 310, the second sensor set 320, the third sensor set 330, the fourth sensor set 340, the first thumb sensor set 350, the second thumb sensor set 360, the communication port 370, and the swapping sensor 380 are physically connected to the casing 390.

The first through fourth sensor set 310-340 are spaced to allow the use of the handheld keyboard with one hand and reach each sensor without the need to move or rotate the keyboard within the palm. The first thumb sensor set 350 and the second thumb sensor set 360 is given to allow the use of the handheld keyboard without needing to move it.

The casing 390 is made up of viscoelastic material. The viscoelasticity refers to the material's reaction in response to a strain. When the viscoelastic material is deformed, unlike other materials, the stress formed within the viscoelastic material reduces with time at the same level of deformation.

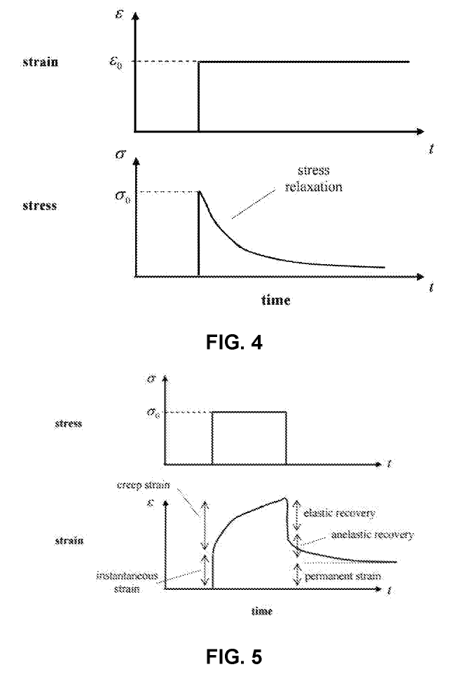

The mechanical properties of a viscoelastic material are described in terms of stress, strain, and time. Viscosity, h, is defined as the ratio of shearing stress to velocity gradient (Newton's law). A viscoelastic material will return to its original shape after any deforming force has been removed (i.e., it will show an elastic response) even though it will take time to do so (i.e., it will have a viscous component to the response). Many biological materials are viscoelastic to a greater or lesser extent. This property allows the casing 390 to feel more natural in a user's hand unlike a plastic casing. The viscoelasticity also increases durability of the viscoelastic handheld keyboard 300 as it does not break when a blunt force is applied such as caused by when a plastic keyboard is dropped to the ground. The viscoelastic casing 390 provides individuals with a soft and individually conforming gripping surface. FIG. 4 shows the strain and stress with relation to the time.

Viscoelastic materials may be characterized by a time-dependent relationship between stress and strain (e.g., the amount of deformation changes over time for a constant stress). The viscoelastic material may have any suitable relation between stress and strain rate. For example, if stress is linearly proportional to the stress rate, the material may be characterized as a linear or Newtonian material. As another example, if stress is not linearly proportional to the stress rate, the material may be characterized as a non-linear or non-Newtonian material. FIG. 5 shows the relationship of constant stress and strain against time.

In its initial un-deformed state, the viscoelastic casing 390 has zero stress and zero strain. When the casing 390 is deformed, i.e. a certain straining force is applied, the casing 390 applies a certain stress to resist the straining force. However, under constant strain, the stress within the viscoelastic casing 390 slowly reduces. This property of viscoelastic materials is commonly called stress-relaxation test.

Similarly, when a constant stress is created with pressure, first the casing 390 is deformed to instantly, then the rate of strain slows down until finally becomes constant. When the stress is removed, the casing 390 starts with a high recovery rate which slows down as time passes. Certain viscoelastic materials may also display permanent deformation, although in preferred embodiments, the viscoelastic material has minimal permanent deformation. The graph below shows the relationship of constant stress and strain against time.

The response of viscoelastic materials may be predicted or calculated using a number of different approaches. For example, for linear viscoelastic materials, strain can be written as the sum of a stress component (e.g., due to a received force) and a creep component (e.g., due to re-arranging of molecules in the material). Other suitable approaches for modeling linear viscoelastic materials may include, for example, the Maxwell model, the Kelvin-Voigt model, the Standard Linear Sold model, or the Generalized Maxwell model. As another example, non-linear viscoelastic materials may be characterized by a complex dynamic modulus representing the relation between the oscillating stress and strain.

The casing 390 is an ultra-soft viscoelastic material. This endows the grip with an inherent tactile feel. The casing 390, as described herein, provides a tacky surface, essential and beneficial for gripping. As those skilled in the art will readily appreciate, the tack level may be readily adjusted with chemical and/or mechanical processing modification.

The surface of casing 390 can be measured in terms of hardness by the Shore A or Shore OO Durometer Test. The present casing 390 have durometers in this scale between approximately 2 and 35, and more preferably 25 or less. The casing 390 is preferably a viscoelastic solid-phase polymer material. The viscoelastic solid-phase polymer material is preferably a styrenic thermoplastic elastomer containing, for example, KRATON, which is manufactured by Shell Chemical Company.

The communication port 370 is used to connect the viscoelastic handheld keyboard 300 to another electronic device using a cable. The cable includes a first wire for data transfer and another wire for power transfer. When a sensor is activated, the viscoelastic handheld keyboard 300 transmits data to the connected electronic device as described in detail in FIGS. 1 and 2.

Each sensor includes an activating pressure to be applied before it activates. The sensors are each push buttons that return to their original position after the sensor is activated. The activating pressure is determined by the model of the sensor that

is used. When the activating pressure is high, the user applies a higher pressure to activate the sensor. The model of the sensor is selected such that it minimizes the possibility of accidentally activating the sensor while allowing the operation of the viscoelastic handheld keyboard 300 without undesirable strain in user's hand or requiring the viscoelastic handheld keyboard 300 from being pushed up against a solid object.

The viscoelastic handheld keyboard 300 also includes a processor within the viscoelastic casing 390. Each of the sensors found on the viscoelastic keyboard is in two way communications with the processor using electrical pins contained on the processor. The copper wire connected to one end of the sensor is loaded with a certain voltage, while the copper wire connected to the other end of the sensor remains zero. The unloaded copper wire is connected to one of the electrical pins on the processor. The sensors are initially in open position.

In operation, a user grasps the casing 390 with the desired hand of operation. When the user grasps the casing 390 with a left hand, the left thumb substantially overlays the second thumb sensor set 360. The index finger substantially overlays the first sensor set 310. The middle finger substantially overlays the second sensor set 320. The ring finger substantially overlays the third sensor set 330. The pinkie finger substantially overlays the fourth sensor set 340. As described in relation to FIGS. 1 and 2, each sensor in the viscoelastic handheld keyboard 300 is assigned a sensor code, and each sensor code is associated with an alphanumeric character.

When the user grasps the casing 390 with a right hand, the right thumb substantially overlays the first thumb sensor set 350. The index finger substantially overlays the fourth sensor set 340. The middle finger substantially overlays the third sensor set 330. The ring finger substantially overlays the second sensor set 320. The pinkie finger substantially overlays the first sensor set 310. As described in relation to FIGS. 1 and 2, each sensor in the viscoelastic handheld keyboard 300 is assigned a sensor code, and each sensor code is associated with an alphanumeric character.

For the left hand operation, the Table 1 shows a list of assignments.

TABLE 1

| | |
|---|---|
| The first sensor 311 | v |
| The second sensor 312 | f |
| The third sensor 313 | r |
| The fourth sensor 321 | c |
| The fifth sensor 322 | d |
| The sixth sensor 323 | e |
| The seventh sensor 331 | x |
| The eight sensor 332 | s |
| The ninth sensor 333 | w |
| The tenth sensor 341 | z |
| The eleventh sensor 342 | a |
| The twelfth sensor 343 | q |
| The first thumb sensor 361 | Space |
| The second thumb sensor 362 | g |
| The third thumb sensor 363 | t |

For the right hand operation, the Table 2 shows a list of assignments.

TABLE 2

| | |
|---|---|
| The first sensor 311 | , |
| The second sensor 312 | L |
| The third sensor 313 | P |
| The fourth sensor 321 | M |
| The fifth sensor 322 | K |
| The sixth sensor 323 | O |
| The seventh sensor 331 | N |
| The eight sensor 332 | J |
| The ninth sensor 333 | I |
| The tenth sensor 341 | B |
| The eleventh sensor 342 | H |
| The twelfth sensor 343 | U |
| The fourth thumb sensor 351 | Y |
| The fifth thumb sensor 352 | . |
| The sixth thumb sensor 353 | ; |

As described in more detail in relation to FIGS. 1 and 2, when the swapping sensor is activated, the processor modifies the alphanumeric set so that the assignment of sensors in the alphanumeric set swaps between the left hand operation and the right hand operation.

When the user applies pressure to one of the sensors, the pressure is transferred through the sensor to the casing 390. Due to the casing's 390 viscoelastic property, the casing 390 deforms under the transferred pressure. As describe above, as the user grasps the casing 390, the deformed casing does not apply the same level of stress to the user's hand constantly. The stress within the casing 390 tapers off to a level below which the user initially applied to deform the casing 390. This allows the casing 390 to form into a user's hand.

It should be appreciated that the elastomer containing, for example, KRATON, may be altered via chemical and manufacturing processes. This alteration would likely include the softening of the thermoplastic elastomer. Also other treatments may be used without departing from the spirit of the present invention. The elastomer may also be modified to enhance its performance characteristics. For example, ultra-violet protection and/or fillers, such as Kevlar (an aramid fiber manufactured by DuPont), may be added to enhance the performance of the elastomer.

In alternative embodiments the viscoelasticity of the casing 390 is selected such that the stress relaxation and strain creep curves are similar to the stress relaxation and strain creep curves of human flesh. The viscoelastic properties of human flesh are shown in various scientific articles, and are known to the person having ordinary skill in the art.

In alternative embodiments the casing 390 is a vulcanizing (RTV) silicone rubber. In an alternative embodiment, the casing 390 has a density of 950 kg/m³, Shore A hardness level of 13.8, and peak impact level of 623 N.

In alternative embodiments, the casing 390 may have a hardness of approximately 1 to 80 Shore OO durometer. The range of hardness is preferably approximately 5 to 70 Shore OO durometer or approximately 5 to 50 Shore OO durometer. In particular, it has been found that a hardness of approximately 5 to 20 Shore OO durometer provides a comfortable grip.

In an alternative embodiment, the casing 390 includes vinyl nitrile with a durometer Type A with durometer hardness 20-90.

In an alternative embodiment, the casing 390 is manufactured using 3D printing device with Layfomm filament materials. In another alternative the casing 390 is manufactured with insert molding, a process characteristic of injection molding. Details of insert molding process is found in the art such as Todd, Robert H.; Allen, Dell K.; Alting, Leo (1994). Manufacturing Processes Reference Guide. Industrial Press, Inc.

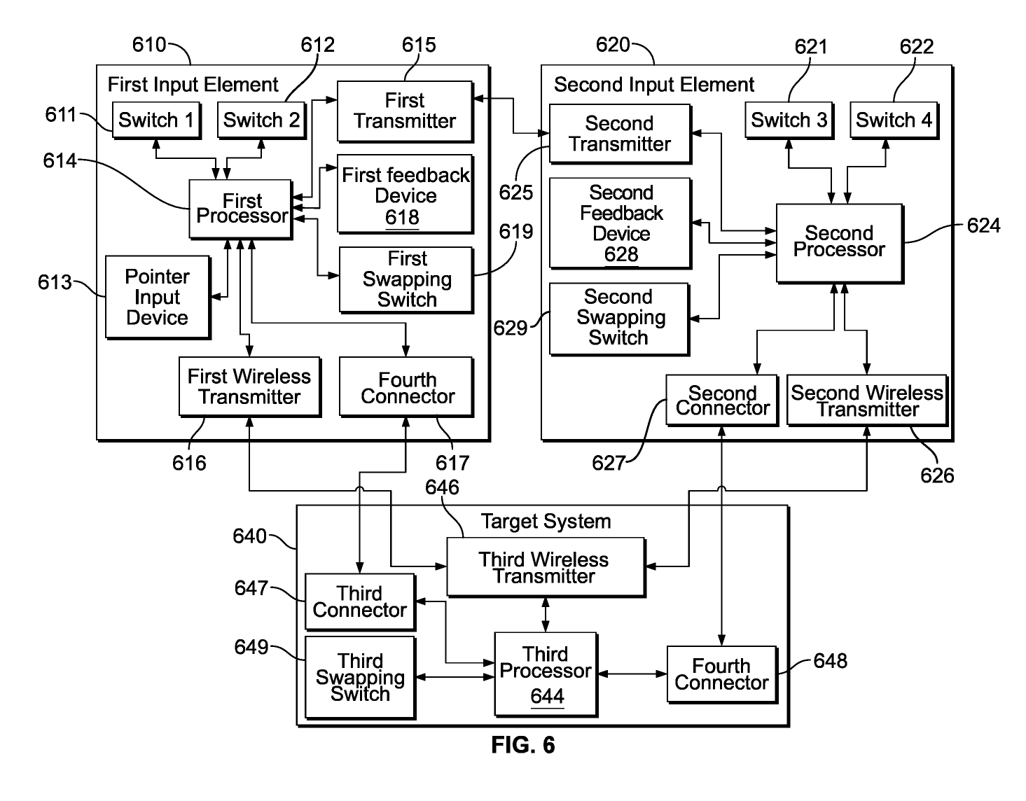

In alternative embodiments, the handheld viscoelastic keyboard 300 may include a power sources housed within the casing 390 to supply power to the system during operation. In another embodiment, the communication port 370 is also capable of providing power to the system when it is connected to a target system or to another handheld viscoelastic keyboard 300 as described below in relation to FIG. 6.

In alternative embodiments, the viscoelastic material used in the casing 390 may be amorphous polymers, semicrystalline polymers, biopolymers, bitumen material, thermoset elastomers, or any other suitable viscoelastic material may be used. In alternative embodiments, the viscoelastic casing 390 may be formed from elastomers such as thermoplastic elastomers, e.g., MONPRENE® (sold by QST, Inc. of St. Albans, Vt.), SANTOPRENE® (exclusively licensed to Advanced Elastomer Systems, L.P. of Akron, Ohio), or DYNAFLEX™ (sold by GLS Corporation of McHenry, Ill.).

In alternative embodiments, the sensors may be glued on to the surface of the casing 390. In further embodiments, the sensors may be attached with pins to the surface of the casing 390. In another embodiment, the sensors can be implemented within the casing 390, with a thin layer of viscoelastic material covering the sensors.

In alternative embodiments, the communication port 370 may be Apple® Lightning® communication port, USB-C, USB-3, micro-USB, or any other standard or non-standard communication port that allows data and power transfer between the viscoelastic handheld keyboard 300 and another electronic device such as a personal computer, a laptop computer, gaming consoles, smart television, cellphones, mobile phones, tablets, or another viscoelastic handheld keyboard.

In an alternative embodiment, the communication port 370 is used to connect the viscoelastic handheld keyboard 300 to another viscoelastic handheld keyboard 300 wherein the first viscoelastic handheld keyboard 300 is in left hand operational state while the second viscoelastic handheld keyboard 300 is in right hand operational state as describe more fully in FIG. 6.

In alternative embodiments, various different key assignments are possible. In alternative embodiments, the user is given an option to change the assignment with the assistance of a computer program when the communication port 380 is connected to a computer using a cable. In such embodiment, the user launches the computer program. The computer assists the user to modify the alphanumeric data set stored in the processor. The user than modifies the associations between the sensor codes and the alphanumeric characters.

In alternative embodiments, there may be more than two alphanumeric sets. In such alternative, each time the swapping sensor is activated the assignment of the keys changes based on a pre-defined order. In alternative embodiments, the viscoelastic handheld keyboard 300 includes a light indicator which identifies the assignment state of the sensors. For example, in one embodiment there may be one light indicator for left hand operation and another light indicator for right hand operation. In another alternative, there may be a single light indicator with multiple colors with a color assigned for the left hand operation, and another color assigned for the right hand operation so that the indicator's color is displayed based on the current operational state of the viscoelastic handheld keyboard 300.

In alternative embodiments, each sensor may include a haptic device operably connected to and configured to receive signals from the processor 314. When one of the sensors is activated, the haptic device in that sensor is activated by the processor 314 and provides an immediate feedback to the user.

In alternative embodiments, the viscoelastic casing 390 may include pathways for the conductive wires to travel within the viscoelastic casing to couple various electrical components and also transfer power to such components.

In an alternative embodiment, the viscoelastic handheld keyboard 300 also includes a battery operably connected to and configured to supply power to the various electrical components in the viscoelastic handheld keyboard 300. In an alternative embodiment, the battery may include wireless charging capabilities such as the ones commonly found in mobile devices.

In alternative embodiments, the viscoelastic handheld keyboard 300 includes only four sensors, an index sensor, a middle sensor, a ring sensor, and a pinkie sensor. In such embodiment, each sensor is assigned more than one alphanumeric character, however the alphanumeric set is arranged such that the number of repeated presses on the same sensor produces different characters. An exemplary alphanumeric set assignment to sensors is provided below in Table 3 for left hand operation.

TABLE 3

| | First | Second | Third | Fourth |
|---|---|---|---|---|
| | activation | activation | activation | activation |
| Index sensor | A | B | C | D |
| The middle sensor | E | F | G | H |
| The ring sensor | I | J | K | L |
| The pinkie sensor | M | N | O | P |

An exemplary alphanumeric set assignment to sensors is provided below in Table 4 for right hand operation.

TABLE 4

| | First | Second | Third | Fourth |
|---|---|---|---|---|
| | activation | activation | activation | activation |
| Index sensor | Q | R | S | T |
| The middle sensor | U | V | W | |
| The ring sensor | X | Y | Z | |
| The pinkie sensor | , | . | ; | : |

In operation, the user activates the right hand index sensor one time. The processor receives a signal from the sensor. Instead of immediately transmitting an electrical signal representing the character “Q”, the processor delays transmission for a certain period of time such as one second. When the user presses the same sensor for the second time within the delay period, the processor again receives a signal from the same sensor and registers the input as character “R”. This arrangement was commonly found in phones where each key is associated with three alphanumeric characters. In alternative embodiments, the processor may display the character to the user on a screen during the delay period. During the second delay period, when the user presses a different sensor, the processor registers first entered input “Q” and then registers the different sensor.

In an alternative embodiment, the viscoelastic handheld keyboard 300 also includes a hand strap. The hand strap is attached the casing 390. In operation the user wraps he strap around his or her hand such that his/her each finger is aligned with one of the sensor sets and his/her thumb is aligned with the thumb sensor set. The strap is preferably an elastic material. The size and elasticity of the strap is selected based on the size of the user's hand.

FIG. 6 illustrates a two-piece handheld keyboard system 600. The handheld keyboard system 600 includes a first input element 610, a second input element 620, a target system 640, a first cable 631, a second cable 632, and a third cable 633. The first input element 610 includes a first sensor 611, a second sensor 612, a first transmitter 615, a first wireless transmitter 616, a first communication port 617, a first feedback device 618, a first swapping sensor 619, a first processor 614, and a pointer input device 613. The second input element 620 includes a third sensor 621, a fourth sensor 622, a second transmitter 625, a second wireless transmitter 626, a second communication port 627 a second swapping sensor 629, a second processor 624, and a second feedback device 628. The target system 640 includes a third wireless transmitter 646, a third communication port 647, a fourth communication port 648, a third swapping sensor 649, and a third processor 644.

In the first input element 610, the first sensor 611, the second sensor 612, the first transmitter 615, the first wireless transmitter 616, the first communication port 617, the first feedback device 618, the first swapping sensor 619, and the pointer input device 613 are in two way communications with and operably coupled to the first processor 614 and operable in use to transmit signals to and receive signals and power from the processor 614.

In the second input element 620, the third sensor 621, the fourth sensor 622, the second transmitter 625, the second wireless transmitter 626, the second communication port 627, the second feedback device 628, and the second swapping sensor 629 are in two way communications with and operably coupled to the second processor 624 and operable in use to transmit signals to and receive signals and power from the processor 624.

In the target system 640, the third communication port 647, the third wireless transmitter 646, the fourth communication port 628, and the third swapping sensor 649 are in two way communications with and operably coupled to the third processor 644, and operable in use to send and receive electrical signals to and from the third processor 644.

The first communication port 617 is in two way communications with and operably coupled to the third communication port 647 using the first cable 631. The first cable 631 includes at least one wire to facilitate two-way electronic communication between the first communication port 617 and the third communication port 647. The second communication port 627 is electronically connected to the fourth communication port 648 using the second cable 632. The second cable 632 includes at least one wire to facilitate two-way communication between the second communication port 627 and the fourth communication port 648. The first wireless transmitter 616 and the second wireless transmitter 626 are operably connected to the third wireless transmitter 646. The first wireless transmitter 616 is capable of transmitting and receiving wireless signals from the third wireless transmitter 646 when they are in range of one another. The second wireless transmitter 626 is capable of transmitting and receiving wireless signals from the third wireless transmitter 646 when they are in range of one another.

The first transmitter 615 is operably connected and in two-way communication with the second transmitter 625 using the third cable 633. The third cable 633 includes at least one wire to facilitate two-way electronic communication between the first transmitter and the second transmitter.

The first input element 610 and the second input element 620 are provided within the viscoelastic casing 390 as described in relation to FIG. 3.

The first processor 614, the second processor 624, and the third processor 644 store data representing an alphanumeric set. The alphanumeric set includes a plurality of sensor codes corresponding to a set of alphanumeric characters. Each sensor code is different and assigned to one of the sensors in the first input element 610 or the second input element 620. The set of alphanumeric characters include characters commonly found in an American computer keyboard. The alphanumeric set also includes three subsets. The first subset includes a subset of the alphanumeric characters and associated sensor codes for the sensors found on the first input element 610. The second subset includes a subset of the alphanumeric characters and associated sensor codes for the sensors found on the second input element 620. The processors 614, 624, 644, also store the association of the first input element 610 with the first subset and the association of the second input element 620 with the second subset. The third subset includes a swapping code associated with the swapping sensor. The first processor 614 include a keyboard identification string unique to the first input element 610. The second processor 624 include a keyboard identification string unique to the second input element 620. The unique keyboard identification strings are used to identify the first input element 610 and the second input element 620, and they are also used to store the association of the first input element 610 with the first subset and the association of the second input element 620 with the second subset. The unique keyboard identification string is a string of letters and numbers. An example of alphanumeric key association is given above in relation to FIG. 3.

Each sensor includes the sensor code assigned to that sensor. The sensor code is a series of numbers and letters identifying the sensor.

In operation, the user initiates keyboard association sequence between the first input element and the target system 640. The user connects the first cable 631 to the first communication port 617 and the third communication port 647. When the first cable 631 is connected, the third processor 644 sends a signal representing an identification command to the first processor 614 through the third communication port 647. When the first communication port 614 receives the signal representing the identification command, it sends a response signal representing the unique keyboard identification string associated with the first input element 610 and a list of sensor codes associated with the sensors in the first input element 610 to the third processor 644 through the first cable 631. The first input element also sends a signal representing an activation command to the first wireless transmitter 616. The first wireless transmitter 616 starts broadcasting the first input element's 610 unique identification string.

When the third processor 644 receives the response signal representing the unique keyboard identification string associated with the first input element 610, it associates the unique keyboard identification associated with the first input element 610 with the first subset. The third processor 644 also sends a command to the first processor 614 that instructs the first processor 614 to associate its unique keyboard identification with the first subset. The third processor 644 also sends an activation command to the third wireless transmitter 646. The third wireless transmitter 646 establishes a connection with the first wireless transmitter 616.

The user then initiates the keyboard association sequence between the second input element 620 and the target system 640. The user connects the second cable 632 to the second communication port 627 and the fourth communication port 648. The system follows the same sequence as above to establish a connection between the second wireless transmitter 626 and the third wireless transmitter 646.

The user connects the third cable 633 to the first transmitter 615 and the second transmitter 625.

The user holds the first input element 610 in her left hand and the second input element 620 in her right hand.

The user then starts the input sequence. When the user applies an activating pressure to one of the sensors, the viscoelastic casing deforms under the pressure until the internal stress within the viscoelastic casing applies an equal and opposite pressure to the activated sensor. The process through which the user activates the sensor is described step by step below in relation to FIG. 6. When the activating pressure is equal to or greater than the pressure required to activate the sensor, the sensor is activated. When the user activates the first sensor 611 or the second sensor 612, the activated sensor sends a signal representing the sensor code to the first processor 614. The first processor 614 identifies the alphanumeric character associated with the sensor code in the alphanumeric set. The first processor 614 then transmits an electrical signal representing the alphanumeric character to the third processor 644 through the first communication port 617, which relays the signal through the first cable 631 to the third communication port, which relays the signal to the third processor 644. The first processor 614 also sends the electrical signal representing alphanumeric character to the first wireless transmitter 616. The first wireless transmitter 616 broadcasts a wireless signal representing the alphanumeric character. When the third wireless transmitter 646 is in range of the first wireless transmitter 616, the third wireless transmitter 646 receives the wireless signal and transforms the signal to an electrical signal representing the same information and send it to the third processor 644. The first processor 614 also sends an activation signal to the first feedback device 619. When the first feedback device 619 receives the activation signal it provides a haptic, a visual, and an audible feedback to the user. The haptic feedback can be provided using a small rotational motor with an uneven weight attached to one end. When the uneven weight is rotated around its axis by the motor it creates a vibration. The visual feedback is provided using a small light such as an LED. The audible feedback is provided using a speaker.

When the user activates a sensor disposed on the second input element 620, a similar input sequence is followed to register the activated sensor in the target system 620.

The user then initiates the swapping sequence. When the user activates the first swapping sensor 619, the first swapping sensor 619 sends an electrical signal representing the swap sensor code to the first processor 614. When the first processor 614 receives the swap sensor code, it removes the association between the first input element's 610 unique keyboard string and the first subset in the alphanumeric set, and associates the first input element's 610 unique keyboard string with the second subset. The first processor 614 also removes the association between the second input element's 620 unique keyboard string and the second subset in the alphanumeric set, and associates the second input element's 610 unique keyboard string with the first subset. The first processor 614 then sends an electrical signal representing the swap sensor code to the second processor 624 and the third processor 644. When the second processor 624 and the third processor 644 receive the signal representing the swap sensor code, both processors independently modify the alphanumeric set to effectuate the change.

The user than initiates the pointer sequence. The pointer input device 613 is an inertial measurement unit to track the motion of the first input element 610 in the air. In such embodiment, the pointer input device 613 include an internal conventional 3-axis accelerometer that detects the earth's gravitational forces in three dimensions and may thus be used as an inclinometer. Such inclination (orientation) information in three axes can be used to control the pointer in a computer screen to provide rough (x, y, z) position information in three dimensions. Signals representing such relative position information can be communicated to target system to control the position of pointer on the screen.

The pointer input device 613 may also be an acceleration sensor, which is a three-axis linear accelerometer that detects linear acceleration along each of an X axis, Y axis and Z axis. Alternatively, a two-axis linear accelerometer that only detects linear acceleration along each of an X axis and Y axis (or other pair of axes) may be used in another embodiment depending on the type of control signals desired. As a non-limiting example, the three-axis or two-axis linear accelerometer may be of the type available from Analog Devices, Inc. or STMicroelectronics N. V. Preferably, the acceleration sensor is an electrostatic capacitance or capacitance-coupling type that is based on silicon micro-machined MEMS (microelectromechanical systems) technology. However, any other suitable accelerometer technology (e.g., piezoelectric type or piezoresistance type) now existing or later developed may be used to provide the three-axis or two-axis acceleration sensor 166.

As one skilled in the art understands, a linear accelerometer, such as acceleration sensor, is only capable of detecting acceleration along a straight line corresponding to each axis of the acceleration sensor. In other words, the direct output of the acceleration sensor is limited to signals indicative of linear acceleration (static or dynamic) along each of the two or three axes thereof. As a result, the acceleration sensor cannot directly detect movement along a non-linear (e.g. arcuate) path, rotation, rotational movement, angular displacement, tilt, position, attitude or any other physical characteristic.

However, through additional processing of the linear acceleration signals output from the acceleration sensor, additional information relating to the first input element can be inferred or calculated, as one skilled in the art will readily understand from the description herein. For example, by detecting static linear acceleration (i.e., gravity), the linear acceleration output of the acceleration sensor can be used to infer tilt of the object relative to the gravity vector by correlating tilt angles with detected linear acceleration. In this way, the acceleration sensor can be used in combination with the first processor 614 (or another processor) to determine tilt, attitude or position of the first input element 610. Similarly, various movements and/or positions of the first input element 610 can be calculated or inferred through processing of the linear acceleration signals generated by the acceleration sensor when the first input element 610 containing the acceleration sensor is subjected to dynamic accelerations by, for example, the hand of a user. In another embodiment, the acceleration sensor may include an embedded signal processor or other type of dedicated processor for performing any desired processing of the acceleration signals output from the accelerometers therein prior to outputting signals to the first processor 614. For example, the embedded or dedicated processor could be used to convert the detected acceleration signal to a corresponding tilt angle when the acceleration sensor is intended to detect static acceleration (i.e., gravity).

In this embodiment, the acceleration sensor and the first processor 614 function as a position and/or attitude determining system for determining the position and/or attitude of the first input element 614 held by the user with his/her hand. By outputting information on the position and/or attitude through conversion of the acceleration signal output from the acceleration sensor, it is possible to obtain a high degree of control over the pointer of a computer with a higher degree of control than traditional computer mouse.

Moreover, the acceleration sensor is provided within the casing 390, and in the course of nature, the thumb is placed on the thumb sensor set and the remaining fingers are placed over the remaining sets of sensors as described in relation to the FIG. 3. Thus, no variations occur among individuals in the way to hold the first input element, which makes it possible to perform high-precision detection without variations under predetermined criteria. Also, since right-handed operation and left-handed operation are asymmetrical, there is no possibility of causing an error when the accelerometer is placed in the center of the casing.

In another embodiment, the pointer input device 613 may be a gyro-sensor of any suitable technology incorporating, for example, a rotating or vibrating element. Exemplary MEMS gyro-sensors that may be used in this embodiment are available from Analog Devices, Inc. Unlike the linear acceleration sensor described above, a gyro-sensor is capable of directly detecting rotation (or angular rate) around an axis defined by the gyroscopic element (or elements) therein. Thus, due to the fundamental differences between a gyro-sensor and a linear acceleration sensor, corresponding changes are made to the processing operations that are performed on the output signals from these devices depending on which device is selected for a particular application. Due to the fact that the nature of gyroscopes is known to one skilled in the art, as well as the fundamental differences between linear accelerometers and gyroscopes, further details are not provided herein so as not to obscure the remainder of the disclosure. While gyro-sensors provide certain advantages due to their ability to directly detect rotational movement, linear acceleration sensors are generally more cost effective when used in connection with the handheld keyboard systems described herein.

In an alternative embodiment, the pointer input device 613 is a four-way joystick such as an e-sensor sold by Digi-Key Electronics. In another alternative the pointer input device is an eight-way joystick. In another alternative embodiment, the pointer input device 613 may include four sensors arranged in fashion similar to arrow keys on a standard computer keyboards. In such alternative, each sensor within the pointer input device 613 includes a sensor code. In the alphanumeric set, the pointer input device's sensor codes are associated with a direction, up, down, left, or right, rather than an alphanumeric character. When one of the sensors in the pointer input device 613 is activated, the pointer in the target systems moves in the direction assigned to the activated sensor. In alternative embodiments, the pointer input device is a two axis navigation sensor as sold by Digi-Key Electronics with part number CKN10345-ND.

In an alternative embodiment, the sensors area push buttons with surface mount as sold by Digi-Key Electronics. In alternative embodiments, the sensors include a light source to illuminate the sensor when the sensor is activated. In another alternative the light source may be on when the device is powered.

In alternative embodiments, the first input element 610 and the second input element 620 may have been previously associated with the target system 640.

In an alternative embodiment the pointer input device 613 may be a force controlled pointing stick device such as the one described in U.S. Pat. No. 7,057,603, or a trackball.

In alternative embodiments, the first input element 610 and the second input element 620 may be identical accept they may include different unique identification strings. In such embodiments, the sensor codes associated with the sensors disposed on the first input element 610 may be identical to the sensor codes associated with the sensors disposed on the second input element 620. In such embodiment during the operation of input sequence, when the first processor sends the electrical signal representing the sensor code associated with the activated sensor to the third processor 644, it includes the first input element's 620 unique identification code as well. In such embodiment, when the third processor 644 receives the signal, it identifies the alphanumeric character associated with the sensor code found in the subset associated with the first input element's 620 the unique identification code.

In an alternative embodiment, the first input element 610 and the second input element 620 may not have a predetermined unique keyboard identification strings. In such embodiments, in operation during keyboard association sequence, when the first input element 610 is connected to the target system 640, the third processor 644 generates either a random string or selects from a predetermined list of unique identification strings and assigns that string as the first input element identification string. The third processor 644 then transmits an electrical signal representing the first input element identification string to the first processor 614. In such embodiment, the system repeats the same processes for the second input element 620 as well.

In an alternative embodiment, the user does not connect the second input element 620 to the target system 640 during the keyboard association sequence. In such embodiment in operation during the keyboard association sequence, the user connects the second input element 620 to the first input element 610 either by connecting first transmitter 615 to the second transmitter 625 using the third cable 633, or by connecting first connecter 617 to the second communication port 627 using either the first cable 631 or the second cable 632. When the connection is made, the second processor 624 communicates with the third processor through the first input element 610. In such embodiment, any communication between the second input element 620 and the target system 640 is relayed through the first input element 610.

In alternative embodiments, the first input element 610 and the second input element 620 include twenty sensors.

In alternative embodiments, the first input element 610 or the second input element 620 may not include the first and second swapping sensors 619, 629. In such embodiment, the user may press a predetermined combination of sensors concurrently or in a predetermined sequence to initiate the swapping sequence.

In alternative embodiments during the swapping sequence, the first processor 614 may only remove the association between the first input element's 610 unique keyboard string and the first subset in the alphanumeric set, and associates the first input element's 610 unique keyboard string with the second subset. In such embodiment, the processor 614 does not modify the association between the second input element's 620 unique keyboard string and the second subset in the alphanumeric set, and associates the second input element's 610 unique keyboard string with the first subset.

In alternative embodiments, the first feedback device 618 may include a plurality of colored light indicators, each colored light indicators associated with a different subset in the alphanumeric set. In such embodiments, during the swapping sequence, the first processor 614 may send a command signal 618 to change the colored light indicator to the indicator associated with the new subset.

In alternative embodiments, the alphanumeric set may include more than two subsets. In such embodiments, each time the swapping sequence is initiated, the first processor 614 modifies the association between the first input element 610 with a new subset in a predetermined sequence.

In an alternative embodiment, the first input element 610 may not include the first transmitter 615 and the second input element 620 may not include the second transmitter 625. In such embodiment, after completing the keyboard association sequence the user connects the first communication port 617 to the second communication port 626 using the first cable 631 or the second cable 632. In such embodiments in operation, the first processor 614 communicates with the second processor 624 using the connection of the second cable 632.

In an alternative embodiment, the first transmitter 615 and the second transmitter 625 may be wireless transmitters operably connected and in two-way wireless communication with one another.

In alternative embodiments, the wireless communications between the first input element 610, the second input element 620, and the target system 640 may be using Bluetooth®. In another embodiment, the wireless communications may take place through wireless direct protocols.

In an alternative embodiment, when a sensor is activated, the first processor 614 may employ either the wireless transmitter 616, or the first communication port 617 to transmit the sensor code to the target system 640. The first processor 640 may include an algorithm to determine the fastest method of communication between the first processor 614 and the fourth processor 644.

In an alternative embodiment, the first processor 614 may not identify the alphanumeric character associated with the sensor code it receives from an activated sensor. In such embodiment in operation, the first processor 614 receives an electrical signal representing the sensor code from the activated sensor. The first processor 614 relays the electrical signal to the third processor 644. The third processor then identifies the alphanumeric character associated with the sensor code in the alphanumeric set.

In an alternative embodiment, the first input element 610 may not have the first wireless transmitter 616. Instead the electrical communications between the first input element 610 and the target system 640 may be made through the first cable 631. In an alternative embodiment, the second input element 620 may not have the second wireless transmitter 626. Instead the electrical communications between the second input element 610 and the target system 640 may be made through the first cable 631.

In an alternative embodiment, the second input element 620 does not include the second communication port 627 and the second wireless transmitter 626. In such alternative, in operation, any communication between the second processor 624 and the target system 640 is relayed through the first input element 610.

In alternative embodiments, the target system may not include the fourth communication port. In such embodiment, after establishing a connection between the first input element 610 and the target system 640, the user may disconnect the first cable 631 with the first communication port 617, and connect the first cable 631 to the second communication port 627.

In alternative embodiments, the first input element's 610 unique keyboard identification string may already be associated with the first subset, and the second input element's 620 unique keyboard identification string may already be associated with the second subset. In an alternative embodiment, when the first input element 610 or the second input element 620 are disconnected from the target system 640, the association of their unique keyboard identification strings may remain stored in the system. In such embodiment, when the user reconnects the first input element 610 and the second input element 620 to the target system, the third processor would not need to re-associate the keyboards with the first and second subsets.

In an alternative embodiment, the first input element 610 may include an activation sensor. When the user engages the activation sensor, the activation sensor turns the first processor 614 on and the first processor sends an electrical signal to the first wireless transmitter 616 to broadcast a connection signal representing the first input element's 610 unique identification string and a request to connect. When the first input element 610 is in range of the third wireless transmitter 446, the third wireless transmitted 446 receives the connection signal and relays the signal to the third processor 644. When the third processor 644 receives the connection signal is associates the first input element 610 with the first subset and continues initiation process.

In an alternative embodiment, the cable may also include a power wire to facilitate transfer of power between the first input element 610 and the second input element 620.

In alternative embodiments, the sensors may not have the capability to store the sensor code. In such alternative, the sensors may simply be connected to a circuit and keep the circuit open in the original position such that electrical current does not flow through the sensor. The first processor 614 and the second processor 624 include a plurality of electronic pin communication ports at least equal to the number of sensors connected to the processor. The first processor 614 includes two pin communication ports and the second processor 624 includes two pin communication ports. The first sensor 614 and the second sensor 612 are electronically connected to first pin communication port and the second pin communication port respectively in the first processor 614 using a conductive wire or conductive electrical pathways, such as those found on printed circuit boards. The conductive wires are preferably arranged such that when the viscoelastic casing deforms, the wires do not get tangled or get caught up in any other part contained inside the viscoelastic casing that could put stress on the wire and disconnect the wire from the sensor or the processor. In such environment in operation, when the user activates the first sensor 611, the first sensor allows the electrical current to flow through the conductive wire. When the first processor 614 detects the electrical current at the first pin communication port, the first processor 614 determines that the first sensor 611 is activated. The first processor then initiates the input procedure by either sending an electrical signal the sensor code associated with the first sensor 611 to the third processor 644 via first wireless transmitter 616, the first communication port 617, or both. In a further alternative embodiment, the first swapping sensor 619 is also connected to the first processor 614 through a third pin communication port.

In an alternative embodiment, the pointer input device 613 is a joystick. In such embodiment, the joystick includes a user controlled protrusion with a loaded conductive line on the other end, a base, and at least two passive conductive lines. The protrusion is physically connected to the base. The passive conductive lines are physically connected to the base. The conductive lines are copper wires that connect to the pin communication port in the processor 614. The loaded conductive line is loaded with voltage. In operation, when the user moves the protrusion to a side, the loaded conductive line comes into physical contact with one of the passive conductive lines. The electrical current passes through the passive conductive line. When the electrical current reaches the processor 614, the processor detects the change in the voltage and registers the input from the user.

One or more of the embodiment of the present invention provides a system and device for entering input into a computer system using a viscoelastic keyboard resting inside of a user's palm. Subject of one or more embodiment of the current invention gives a comfortable and convenient solution to removing the strain placed on the user's arms, wrists, and shoulders from operating a computer keyboard for extended periods of time. Incorporating viscoelastic material into as the keyboard's casing provides a light weight alternative to a traditional flat keyboards. It allows the user to sit back and use his or her computer without additional stress in the arms, shoulders, and back muscles.

Subject of one embodiment of the current invention provides a system and device for entering alphanumeric input into a computer system. Prior devices targeted to replacing traditional keyboards are required to be resting on a flat surface even if a round shape is provided for the user to hold.

Subject of one embodiment of the current invention in certain embodiments includes the use of two handheld controllers to enter data into computer. '296 patent is aimed at using a single device and a button layout to allow a user to replace two handed control for single device and it does not disclose a two-piece keyboard system. Further, the only type of pointer control the '296 patent is a regular computer mouse, whereas the subject of one or more embodiments of the current invention includes accelerometers to generate pointer control inputs.

Subject of one embodiment of the current invention discloses a system for entering alphanumeric input into a computer by providing the two handheld controllers. The '853 patent does not disclose the use of the casing for use in keyboards. The '853 patent also does not disclose the use of accelerometers or trackballs to generate pointer input. Further, the subject of the '853 patent requires different placements for left hand and right hand operation and does not provide an efficient way to sensor between a left hand control and a right hand control.

None of the prior art methods disclose the use of viscoelastic material as a casing for a handheld keyboard or computer input system. The subject of one embodiment of the current invention provides a viscoelastic grasping surface unlike the prior devices that aim at finding an ergonomic placement for keyboard buttons for operation with one hand.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An electronic input system including:
a plurality of entry elements, wherein each entry element includes a plurality of sensors; and
a processor, wherein each of the plurality of sensors are in two-way communication with the processor,
wherein the processor stores data representing an alphanumeric set,
wherein the alphanumeric set includes a plurality of sensor codes corresponding to a plurality of sets of alphanumeric characters, wherein each sensor code is associated with one of the plurality of sensors,
wherein each of the plurality of sets of alphanumeric characters includes a plurality of activation counts for said plurality of sensors,
wherein each activation count is associated with an alphanumeric character,
wherein the processor determines as entry data a first alphanumeric character when the number of times a sensor is activated is equal to a first activation count associated with the first alphanumeric character, and
wherein the processor determines as entry data a second alphanumeric character when the number of times said sensor is activated is equal to a second activation count associated with a second alphanumeric character, wherein the second alphanumeric character is different than the first alphanumeric character.

2. The electronic input system of claim 1, wherein each entry element includes a communicator operably connected to the processor for exporting entry data from each entry element.

3. The electronic input system of claim 1, wherein the alphanumeric character is individually selectable for each number of activation count and the sensor.

4. The electronic input system of claim 1, wherein the plurality of sensors are push switches.

5. The electronic input system of claim 1, wherein each entry element also includes a direction control unit operably connected to and in two-way communication with the processor.

6. The electronic input system of claim 5, wherein the direction control unit is selected from a group consisting of a joystick, a d-pad, a gyroscope, an accelerometer, and a trackball.

7. The electronic input system of claim 1, wherein each entry element also includes an accelerometer operably connected to and in two-way communication with the processor.

8. The electronic input system of claim 1, wherein each entry element's exterior surface is viscoelastic with a shore A hardness scale between 10 and 50.

9. An electronic input system including:
a plurality of handheld entry elements,
wherein each entry element includes a deformable exterior surface, a plurality of sensors and a processor, wherein each of the plurality of sensors are in two-way communication with the processor,
wherein the processor stores data representing an alphanumeric set,
wherein the alphanumeric set includes a plurality of sensor codes corresponding to a plurality of sets of alphanumeric characters, wherein each sensor code is associated with one of the plurality of sensors,
wherein each of the plurality of sets of alphanumeric characters includes a plurality of activation counts for said plurality of sensors,
wherein each activation count is associated with an alphanumeric character.

10. The electronic input system of claim 9, wherein each entry element includes a communicator operably connected to the processor for exporting entry data from each entry element.

11. The electronic input system of claim 9, wherein the alphanumeric character is individually selectable for each number of activation count and the sensor.

12. The electronic input system of claim 9, wherein the plurality of sensors are push switches.

13. The electronic input system of claim 9, wherein each entry element also includes a direction control unit operably connected to and in two-way communication with the processor.

14. The electronic input system of claim 13, wherein the direction control unit is selected from a group consisting of a joystick, a d-pad, a gyroscope, an accelerometer, and a trackball.

15. The electronic input system of claim 9, wherein each entry element also includes an accelerometer operably connected to and in two-way communication with the processor.

16. The electronic input system of claim 9, wherein each entry element's exterior surface is viscoelastic with a shore A hardness scale between 10 and 50.

17. The electronic input system of claim 9, wherein the processor determines as entry data a first alphanumeric character when the number of times a sensor is activated is equal to a first activation count associated with the first alphanumeric character, and
wherein the processor determines as entry data a second alphanumeric character when the number of times said sensor is activated is equal to a second activation count associated with a second alphanumeric character, wherein the second alphanumeric character is different than the first alphanumeric character.

18. A computer input device including:
a viscoelastic casing,
wherein the viscoelastic casing has a shore A hardness level between 10 and 50; and
a plurality of sensors disposed on the viscoelastic casing, wherein each sensor is in two-way communication with the processor,
wherein the processor stores data representing an alphanumeric set,
wherein the alphanumeric set includes a plurality of sensor codes corresponding to a plurality of sets of alphanumeric characters, wherein each sensor code is associated with one of the plurality of sensors,
wherein each set of alphanumeric characters includes a plurality of activation counts for said plurality of sensors wherein each activation count is associated with an alphanumeric character, wherein each activation count is different.

19. The computer input device of claim 18 further including a direction control unit selected from a group consisting of a trackball, a gyroscope, a three axis accelerometer, a two axis accelerometer, a d-pad, and a joystick.

20. The computer input device of claim 18, wherein the processor determines as entry data a first alphanumeric character when the number of times a sensor is activated is equal to a first activation count associated with the first alphanumeric character, and
wherein the processor determines as entry data a second alphanumeric character when the number of times said sensor is activated is equal to a second activation count associated with a second alphanumeric character, wherein the second alphanumeric character is different than the first alphanumeric character.
